(19) United States
(12) Patent Application Publication
(10) Pub. No.: US 2026/0222275 A1
(43) Pub. Date: Jul. 30, 2026

(54) SYSTEMS AND METHODS FOR INITIATING A CORRECTIVE ACTION WITHIN A MARSHALING ENVIRONMENT

(71) Applicant: Ford Global Technologies, LLC, Dearborn, MI (US)

(72) Inventors: Krishna Bandi, Novi, MI (US); Stuart C. Salter, White Lake, MI (US); Brendan Diamond, Naples, FL (US); Vyas Darshan Shenoy, Canton, MI (US); Ryan O'Gorman, Beverly Hills, MI (US); Mario Anthony Santillo, Canton, MI (US)

(73) Assignee: Ford Global Technologies, LLC, Dearborn, MI (US)

(21) Appl. No.: 19/038,223

(22) Filed: Jan. 27, 2025

(51) Int. Cl. H04L 41/0654; H04B 17/318; H04L 49/55

(52) U.S. Cl. CPC H04L 41/0654; H04B 17/318; H04L 49/557

(57) ABSTRACT

A method includes the monitoring of one or more characteristics associated with a wireless communication link between an automated vehicle and an infrastructure system, a prediction of one or more connectivity-related issues associated with the wireless communication link, and an initiation of one or more corrective actions in response to predicting the one or more connectivity-related issues.

### FIELD

The present disclosure relates to initiating a corrective action, and more particularly, initiating a corrective action relating to connectivity issues associated with a communication link between a vehicle and a marshaling system.

### BACKGROUND

The statements in this section merely provide background information related to the present disclosure and may not constitute prior art.

Vehicle marshaling within a marshaling environment is typically supported by wireless communication between a marshaling system and the marshaled vehicles. However, the wireless communication can be degraded for any number of reasons and, as such, can result in a loss of active wireless communication, a disruption in a manufacturing process, or other signal disruption-related issues.

The present disclosure addresses these and other issues related to the monitoring of the marshaled vehicles as a basis for initiating a corrective action.

### SUMMARY

This section provides a general summary of the disclosure and is not a comprehensive disclosure of its full scope or all of its features.

The present disclosure provides a method comprising: monitoring one or more characteristics associated with a first wireless communication link between an automated vehicle and an infrastructure system; predicting one or more connectivity-related issues associated with the first wireless communication link based on one or more inputs; and initiating one or more corrective actions in response to predicting the one or more connectivity-related issues, wherein the one or more corrective actions includes causing one or more signal-boosting drones to be deployed within proximity of the automated vehicle; wherein the one or more characteristics associated with the first wireless communication link between the automated vehicle and the infrastructure system includes a signal strength, a signal quality, or a combination thereof; wherein the prediction of the one or more connectivity-related issues associated with the first wireless communication link comprises: determining whether a received signal strength satisfies a signal strength-related threshold; wherein the prediction of the one or more connectivity-related issues associated with the first wireless communication link comprises: determining whether a signal-to-noise ratio or a bit error rate satisfies a signal quality-related threshold; wherein the one or more inputs includes radio-frequency sensor data, a time associated with the one or more characteristics, a temperature, a humidity, or a combination thereof; wherein causing the one or more signal-boosting drones to be deployed within proximity of the automated vehicle comprises: establishing a second communication link between the one or more signal-boosting drones and the automated vehicle; and mitigating the one or more connectivity-related issues in response to the establishment of the second communication link, wherein the mitigation of the one or more connectivity-related issues causes the first communication link to satisfy a signal strength-related threshold and a signal quality-related threshold; and wherein the initiation of the one or more corrective actions further comprises: establishing a second communication link between the automated vehicle and one or more adjacent vehicles relative to the automated vehicle; and mitigating the one or more connectivity-related issues in response to the establishment of the second communication link, wherein the mitigation of the one or more connectivity-related issues causes the first communication link to satisfy a signal strength-related threshold and a signal quality-related threshold.

The present disclosure provides a system comprising: a vehicle system configured to: monitor one or more characteristics associated with a first wireless communication link between an automated vehicle and an infrastructure system, predict one or more connectivity-related issues associated with the first wireless communication link based on one or more inputs, and initiate one or more corrective actions in response to predicting the one or more connectivity-related issues; and one or more signal-boosting drones configured to: proceed to a location within a proximity of the automated vehicle in response to the initiation of the one or more corrective actions; wherein the one or more characteristics associated with the first wireless communication link between the automated vehicle and the infrastructure system includes a signal strength, a signal quality, or a combination thereof; wherein the vehicle system configured to predict the one or more connectivity-related issues associated with the first wireless communication link is further configured to: determine whether a received signal strength satisfies a signal strength-related threshold; or determine whether a signal-to-noise ratio or a bit error rate satisfies a signal quality-related threshold; wherein the one or more inputs includes radio-frequency sensor data, a time associated with the one or more characteristics, a temperature, a humidity, or a combination thereof; wherein the vehicle system is further configured to: establish a second communication link between the one or more signal-boosting drones and the automated vehicle; and mitigate the one or more connectivity-related issues in response to the establishment of the second communication link, wherein the mitigation of the one or more connectivity-related issues causes the first communication link to satisfy a signal strength-related threshold and a signal quality-related threshold; wherein the vehicle system is further configured to: establish a second communication link between the automated vehicle and one or more adjacent vehicles relative to the automated vehicle; and mitigate the one or more connectivity-related issues in response to the establishment of the second communication link, wherein the mitigation of the one or more connectivity-related issues causes the first communication link to satisfy a signal strength-related threshold and a signal quality-related threshold; and wherein the infrastructure system is configured to: stitch one or more sensor-related outputs received from the one or more signal-boosting drones and one or more adjacent vehicles relative to the automated vehicle; adjust, based on stitching the one or more sensor-related outputs, a radio-frequency signal frequency, an antenna output power, or a combination thereof; and cause the one or more connectivity-related issues to be mitigated in response to the adjustment of the radio-frequency signal frequency, the antenna output power, or the combination thereof.

The present disclosure provides one or more non-transitory computer-readable media storing processor-executable instructions that, when executed by at least one processor, cause the at least one processor to: monitor one or more characteristics associated with a first wireless communication link between an automated vehicle and an infrastructure system; predict one or more connectivity-related issues associated with the first wireless communication link based on one or more inputs; and initiate one or more corrective actions in response to predicting the one or more connectivity-related issues, wherein the one or more corrective actions includes causing one or more signal-boosting drones to be deployed within proximity of the automated vehicle; wherein the one or more characteristics associated with the first wireless communication link between the automated vehicle and the infrastructure system includes a signal strength, a signal quality, or a combination thereof; wherein the at least one processor caused to predict the one or more connectivity-related issues associated with the first wireless communication link is further caused to: determine whether a received signal strength satisfies a signal strength-related threshold; or determine whether a signal-to-noise ratio or a bit error rate satisfies a signal quality-related threshold; wherein the one or more inputs includes radio-frequency sensor data, a time associated with the one or more characteristics, a temperature, a humidity, or a combination thereof; wherein the at least one processor caused to cause the one or more signal-boosting drones to be deployed within proximity of the automated vehicle is further caused to: establish a second communication link between the one or more signal-boosting drones and the automated vehicle; and mitigate the one or more connectivity-related issues in response to the establishment of the second communication link, wherein the mitigation of the one or more connectivity-related issues causes the first communication link to satisfy a signal strength-related threshold and a signal quality-related threshold; and wherein the at least one processor caused to initiate the one or more corrective actions is further caused to: establish a second communication link between the automated vehicle and one or more adjacent vehicles relative to the automated vehicle; and mitigate the one or more connectivity-related issues in response to the establishment of the second communication link, wherein the mitigation of the one or more connectivity-related issues causes the first communication link to satisfy a signal strength-related threshold and a signal quality-related threshold.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an implementation of a system for automated vehicle marshaling in accordance with one or more embodiments of the present disclosure;

FIG. 4 is a flowchart illustrating an example method for initiating one or more corrective actions within a marshaling environment in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for identifying one or more connectivity-related issues in a marshaling environment and deploying various solutions for addressing the one or more connectivity-related issues. In one or more examples, the systems and methods described herein provide a means for a vehicle to actively (and/or passively) monitor signal strength and/or signal quality associated with various wireless communication mediums utilized for marshaling the vehicle.

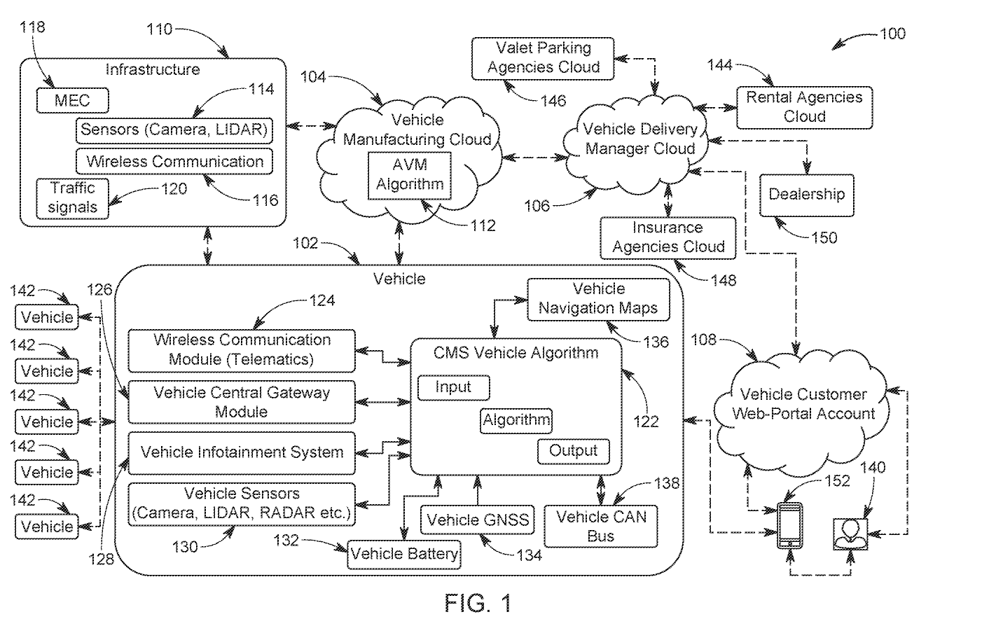

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

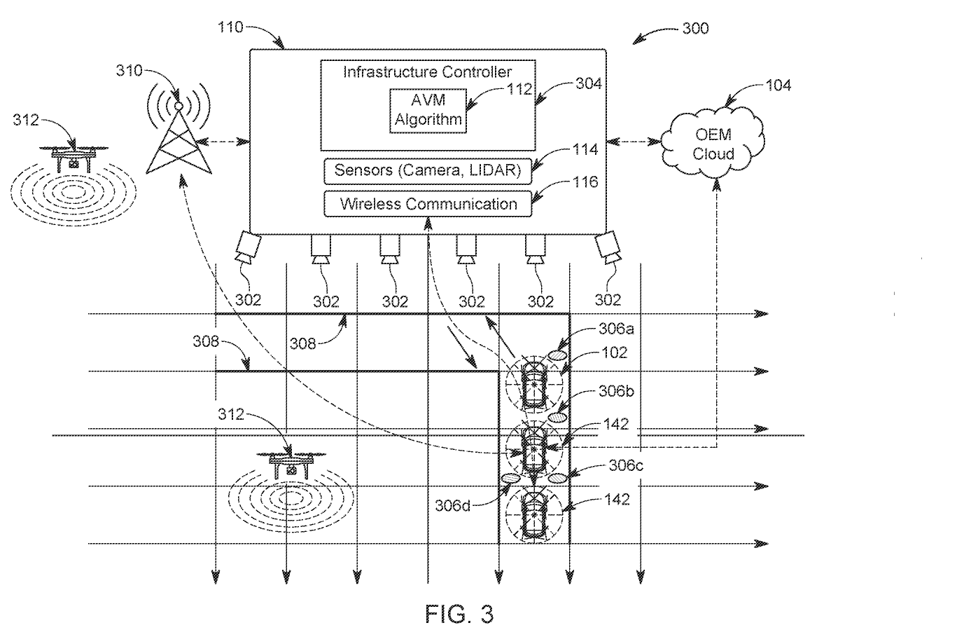

The vehicle manufacturing cloud system 104 can include an infrastructure-side AVM algorithm 112. However, it is understood that the infrastructure system 110 can include the infrastructure-side AVM algorithm 112 as well, as is shown in FIG. 3. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, a parking setting, among others. As an example, the plant marshaling setting can include an instance wherein just-built vehicles are moved through end-of-line testing at a vehicle assembly plant via overhead vision sensing (e.g., via a set of infrastructure sensors 302 as shown in FIG. 3). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is also configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth^{®} to communicate with the one or more vehicles.

The wireless communication component 116 also communicates with the sensor component 114 that is configured to communicate with and/or manage the set of infrastructure sensors 302, as is described herein. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include, but is not limited to, a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is located relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as, but not limited to, the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agency cloud system 144, a valet parking agency cloud system 146, an insurance agency cloud system 148, and/or a dealership system 150. The vehicle delivery manager cloud system 106 is configured to facilitate the delivery of the one or more vehicles to, for example, any of a rental agency (not shown) associated with the rental agency cloud system 144, a valet parking agency (not shown) associated with the valet parking agency cloud system 146, an insurance agency (not shown) associated with the insurance agency cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as, but not limited to, a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agency cloud system 144, the valet parking agency associated with the valet parking agency cloud system 146, the insurance agency associated with the insurance agency cloud system 148, and/or the dealership system 150.

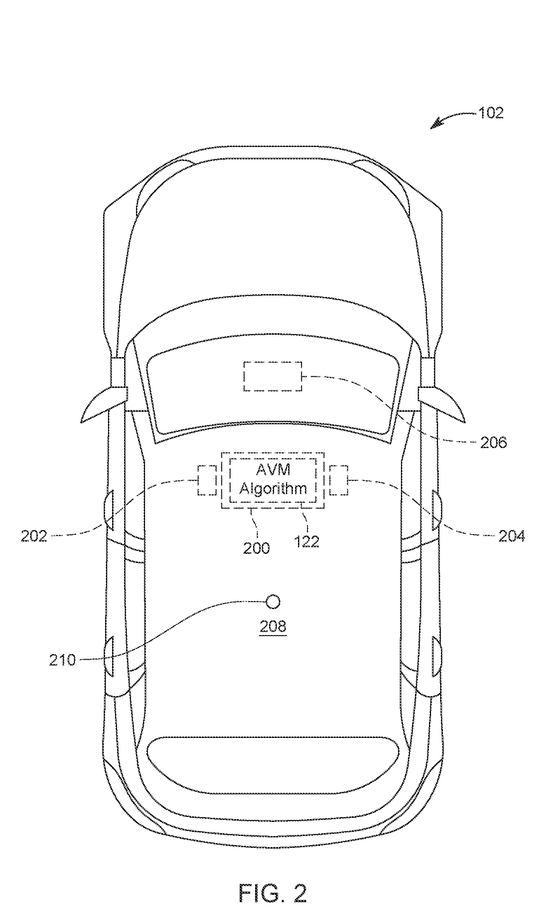

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes a vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The plurality of on-board sensors 204 includes a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensor(s) affixed to one or more bumpers of the vehicle(s) 102 that may provide locations of the object(s) relative to the location of each of the vehicle(s) 102. As yet another example, one or more of the plurality of on-board sensors 204 can be configured to monitor one or more functionalities associated with one or more internally-based components of the vehicle(s) 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be programmed to determine a current vehicle location based on location coordinates (e.g., GPS coordinates) received from the vehicle(s) 102 indicative of a location of the vehicle(s) 102 from a GPS sensor (not shown).

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programmed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for various communications on a vehicle communication network (not shown) that can include a bus in the vehicle(s) 102 such as a CAN, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as is discussed below, various other controllers and/or sensors provide data to the vehicle controller 200 via the vehicle communication network.

In addition, the vehicle controller 200, via the vehicle-side AVM algorithm 122, is also configured for communicating through a vehicle-to-infrastructure communication network, such as communicating with an infrastructure controller (e.g., an infrastructure controller 304 as shown in FIG. 3). The vehicle controller 200, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The HMI 206 is configured to receive information from the human operator during operation of the vehicle(s) 102. Moreover, the HMI 206 is configured to present information to the human operator, such as an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

In one or more embodiments, FIG. 3 shows a system 300 configured to provide a means for identifying and/or predicting one or more connectivity-related issues within the marshaling environment. More particularly, the system 300 is configured to provide a means for identifying and/or predicting one or more connectivity-related issues associated with a communication link established between at least the vehicle 102 (e.g., and/or the one or more additional vehicles 142) and the infrastructure system 110. In one or more examples, the connectivity-related issues can include but are not limited to, a lost communication signal between the vehicle 102 (e.g., and/or the one or more additional vehicles 142) and the infrastructure system 110, a weak communication signal between the vehicle 102 (e.g., and/or the one or more additional vehicles 142) and the infrastructure system 110, an inconsistent communication signal between the vehicle 102 (e.g., and/or the one or more additional vehicles 142) and the infrastructure system 110, among others. In one or more embodiments, the identification and/or prediction of the one or more connectivity-related issues associated with the communication link established between at least the vehicle 102 (e.g., and/or the one or more additional vehicles 142) and the infrastructure system 110 can be quantified (e.g., determined) based on a signal strength and/or a signal quality corresponding to one or more locations of the marshaling environment.

In one or more examples, the quantification of the one or more connectivity-related issues is based on a received signal strength indicator (RSSI) corresponding to the signal strength associated with the one or more locations of the marshaling environment. In one or more examples, the quantification of the one or more connectivity-related issues is based on quality of the signal and/or transmission accuracy of the signal. As another example, the quality of the signal can be indicative of a signal-to-noise ratio associated with the signal. As yet another example, the transmission accuracy of the signal can be indicative of a bit-error-rate associated with the signal. However, it is understood that any metric associated with the signal strength and/or the signal quality may be considered in the quantification of the one or more connectivity-related issues such as, but not limited to, a data transfer rate, a signal-to-interference plus noise ratio (SINR), a reference signal received quality (RSRQ), among others. It is also understood that any connectivity-related metric may be considered in the quantification of the one or more connectivity-related issues.

In one or more embodiments, the one or more connectivity-related issues is identified and/or predicted by the vehicle 102 (e.g., and/or the one or more additional vehicles 142) actively monitoring the signal strength and/or the signal quality of each of the locations of the marshaling environment as the vehicle 102 traverses (e.g., travels across) the marshaling environment. However, it is understood that the one or more connectivity-related issues is identified and/or predicted by the vehicle 102 (e.g., and/or the one or more additional vehicles 142) actively monitoring any communication-related characteristic associated with any of the locations of the marshaling environment as the vehicle 102 traverses the marshaling environment. More specifically, and in one or more examples, the system 300 can provide for the identification and/or prediction of the one or more connectivity-related issues based on one or more inputs (e.g., information) exchanged between the vehicle 102 (e.g., and/or the one or more additional vehicles 142), the vehicle manufacturing cloud system 104, and the infrastructure system 110.

In one or more embodiments, the one or more inputs exchanged between the vehicle 102 (e.g., and/or the one or more additional vehicles 142), the vehicle manufacturing cloud system 104, and the infrastructure system 110 is supported by the exchange of one or more infrastructure marshaling messages (IMMs) and one or more vehicle marshaling messages (VMMs). In one or more embodiments, the exchange of the one or more IMMs and the one or more VMMs is facilitated by the communication link established between at least the vehicle 102 and the infrastructure system 110. In one or more examples, the one or more inputs associated with the identification and/or prediction of the one or more connectivity-related issues related to the communication link is dynamically monitored (e.g., in real-time) by the vehicle 102 (e.g., and/or the one or more additional vehicles 142) and can include, but is not limited to, radio-frequency (RF) sensor data, a time associated with the one or more characteristics (e.g., a time of day, a time of week, etc.), a temperature, a humidity, or a combination thereof. As is described herein, the one or more inputs can be relied upon as a basis for the identification and/or the prediction of the one or more connectivity-related issues related to the communication link and/or the marshaling environment as a whole, which initiates one or more corrective actions to be performed.

In one or more embodiments, the infrastructure system 110 includes the sensor component 114 that communicates with the set of infrastructure sensors 302. The set of infrastructure sensors 302 are configured to monitor the movement of the vehicle 102 (e.g., and/or the one or more additional vehicles 142) as the vehicle 102 (e.g., and/or the one or more additional vehicles 142) moves through the marshaling environment. The infrastructure system 110 also includes the wireless communication component 116 that provides for communication between the infrastructure system 110 and the vehicle 102 (e.g., and/or the one or more additional vehicles 142).

Additionally, the infrastructure system 110 includes the infrastructure controller 304. The infrastructure controller 304 is configured to centrally control an operation of the vehicle 102 (e.g., and/or the one or more additional vehicles 142). For example, the operation of the vehicle 102 (e.g., and/or the one or more additional vehicles 142) include propulsion, braking, and/or steering of the vehicle 102 (e.g., and/or the one or more additional vehicles 142). It is understood that the infrastructure controller 304 may be disposed within the infrastructure system 110 or externally located relative to the infrastructure system 110. The infrastructure controller 304 includes the infrastructure-side AVM algorithm 112 that is configured to facilitate communication between the infrastructure controller 304 and the vehicle controller 200 associated with the vehicle 102 (e.g., and/or the one or more additional vehicles 142).

In one or more embodiments, movement of the vehicle 102 (e.g., and/or the one or more additional vehicles 142) through the manufacturing environment is monitored based on the exchange of the one or more IMMs and the one or more VMMs between the vehicle 102 (e.g., and/or the one or more additional vehicles 142) and the infrastructure system 110. In one or more examples, and in a case wherein the vehicle 102 (e.g., and/or the one or more additional vehicles 142) is not able to communicate with the infrastructure system 110 after an ignition of the vehicle 102 (e.g., and/or the one or more additional vehicles 142 is turned on), the infrastructure-side AVM algorithm 112 is configured to store any exchanged IMM and/or VMM-related data in batches and upload the IMM and/or the VMM-related data to the vehicle manufacturing cloud system 104 or any database associated with the infrastructure system 110. For example, the upload of the IMM and/or the VMM-related data provides one or more data points so that the infrastructure-side AVM algorithm 112 can maintain awareness of a status associated with a previous state of action corresponding to the vehicle 102 (e.g., and/or the one or more additional vehicles 142). However, and in an instance wherein the infrastructure-side AVM algorithm 112 is not tasked with controlling the vehicle 102 (e.g., and/or the one or more additional vehicles 142), the vehicle 102 (e.g., and/or the one or more additional vehicles 142) will still transmit one or more current vehicle control state characteristics to the infrastructure-side AVM algorithm 112 so that the infrastructure-side AVM algorithm 112 can at least passively monitor the vehicle 102 (e.g., and/or the one or more additional vehicles 142).

It is understood that the movement of the vehicle 102 through the manufacturing environment can also be monitored based on an exchange of VMMs directly with any vehicle of the one or more additional vehicles 142 or vice versa. It is additionally understood that the vehicle-side AVM algorithm 122 is configured to monitor the movement of the vehicle 102 (e.g., and/or the one or more additional vehicles 142) itself. For example, the vehicle-side AVM algorithm 122 is configured to be internally aware of which RF frequencies, physical cell identifiers, and/or RF performance metrics of the physical cell identifiers are expected within a geo-fenced area 308. As another example, the vehicle-side AVM algorithm 122 is also configured to determine whether the RF frequencies, physical cell identifiers, and/or the RF performance metrics of the physical cell identifiers match or exceed the expectation with the geo-fenced area 308 based on a regression evaluation and/or validation used as baseline inputs.

In one or more embodiments, the vehicle-side AVM algorithm 122 is configured to determine whether a received signal strength satisfies a signal strength-related threshold. In one or more examples, the signal strength-related threshold can represent a predefined signal strength-related value indicative of an acceptable signal strength-related value. It is understood that the acceptable signal strength-related value corresponds to a range of values that allow for proper functioning of a marshaling relationship between the vehicle 102 (e.g., and/or the one or more additional vehicles 142), the vehicle manufacturing cloud system 104, and the infrastructure system 110. It is also understood that the range of values that correspond to the acceptable signal strength-related value can be any range of values.

The vehicle-side AVM algorithm 122 is also configured, in one or more embodiments, to determine whether a signal-to-noise ratio and/or a bit error rate satisfies a signal quality-related threshold. In one or more examples, the signal quality-related threshold can represent a predefined signal quality-related value indicative of an acceptable signal quality-related value. It is understood that the acceptable signal quality-related value corresponds to a range of values that allow for proper functioning of a marshaling relationship between the vehicle 102 (e.g., and/or the one or more additional vehicles 142), the vehicle manufacturing cloud system 104, and the infrastructure system 110. It is also understood that the range of values that correspond to the acceptable signal quality-related value can be any range of values.

One or more areas associated with the marshaling environment that the vehicle-side AVM algorithm 122 has determined does not satisfy the signal strength-related threshold and/or the signal quality-related threshold can correspond to one or more trouble spots 306a-306d (e.g., areas associated with potential connectivity-related issues). In one or more examples, the vehicle 102 (e.g., and/or the one or more additional vehicles 142) may utilize the one or more vehicle sensors 130 and/or RF signal-mapping characteristics to detect the one or more trouble spots 306a-306d. As an example, the vehicle 102 (e.g., and/or the one or more additional vehicles 142) can detect the one or more trouble spots 306a-306d based on a change in a frequency latch and/or a change in physical cell identifiers as received from one or more neighboring cells representative of areas of the marshaling environment. As an additional example, the vehicle 102 (e.g., and/or the one or more additional vehicles 142) can further detect the one or more trouble spots 306a-306d based on a change in a frequency latch and/or a change in physical cell identifiers associated with RF performance where there is any intermittent effect starting on an automated marshaling protocol by an increase in the latency, round-trip time (RTT), interpacket gap (IPG), congestion, additional reception of the neighboring physical cell identifiers, degradation in the signal strength (e.g., RSSI), reference signal received power (RSRP), RSRQ, the SINR, packet loss, throughput, and/or any other marshaling-related metric or operational characteristic.

As yet another example, the vehicle 102 (e.g., and/or the one or more additional vehicles 142) can detect any degradation in performance when the vehicle 102 and the one or more additional vehicles 142 are located at respective cells and a shifting/latching/un-latching protocol begins to affect a level of degradation in the performance associated with any unknown neighboring cells. The vehicle 102 (e.g., and/or the one or more additional vehicles 142) can also detect shift patterns associated with the physical cell identifiers of the manufacturing environment at different times in a day, for example.

The vehicle 102 (e.g., and/or the one or more additional vehicles 142) may also utilize the vehicle-side AVM algorithm 122 to analyze (e.g., process) information received from the one or more vehicle sensors 130 and/or RF signal-mapping characteristics associated with the one or more trouble spots 306a-306d. For example, the vehicle-side AVM algorithm 122 may analyze the information associated with the one or more trouble spots 306a-306d based on a function associated with the detection of the one or more trouble spots 306a-306d and its associated RF performance. As another example, the function can be representative of latency one-way; RTT; IPG; RSRP; RSRQ; RSSI; SINR; interference; packet-loss; throughput; start/end physical cell identifiers; frequency channels and bands monitoring of indoors/outdoors; cell identifiers; and/or start/end evolvednodeBs (eNBs). It is understood that the function can be representative of any other value associated with the detection of the one or more trouble spots 306a-306d and its associated RF performance, however.

The vehicle 102 (e.g., and/or the one or more additional vehicles 142) are configured to alert (e.g., inform) the infrastructure system 110 and/or the vehicle manufacturing cloud system 104 of the one or more trouble spots 306a-306d as the vehicle 102 (e.g., and/or the one or more additional vehicles 142) is marshaled through the marshaling environment. For example, the alert may be transmitted (e.g., via the one or more VMMs) to the infrastructure system 110 and/or the vehicle manufacturing cloud system 104 via a live reporting protocol. In other words, the location of the one or more trouble spots 306a-306d are reported by the vehicle 102 (e.g., and/or the one or more additional vehicles 142) in real-time (e.g., live). It is understood, however, that the location of the one or more trouble spots 306a-306d may be reported by the vehicle 102 (e.g., and/or the one or more additional vehicles 142) at regular or irregular time-related intervals, for example.

In one or more embodiments, the vehicle 102 (e.g., and/or the one or more additional vehicles 142) may be configured to evaluate whether the interference and/or degradation associated with the one or more trouble spots 306a-306d exceed a performance threshold. As a further example, in an instance wherein the performance threshold is exceeded, the vehicle 102 (e.g., and/or the one or more additional vehicles 142) transmit the location of the one or more trouble spots 306a-306d to the infrastructure system 110 and/or the vehicle manufacturing cloud system 104. It is understood that the performance threshold may be any predefined value associated with successful marshaling of the vehicle 102 (e.g., and/or the one or more additional vehicles 142) through the marshaling environment. It is also understood that the performance threshold may be related to communication or any other performance-related criteria.

In one or more embodiments, and in response to receiving the alert, the infrastructure system 110 is configured to transmit a request for a system operator and/or a repair technician indicating the location of a particular trouble spot corresponding to the alert received by the infrastructure system 110 so that the system operator and/or the repair technician can fix the connectivity-related issue(s). However, it is understood that the vehicle 102 (e.g., and/or the one or more additional vehicles 142) can directly transmit the request for the system operator and/or the repair technician to fix the connectivity-related issue(s). In one or more embodiments, and in response to receiving the alert, the infrastructure system 110 is further configured to adjust RF signal frequency and/or an antenna output power to enhance signal strength, signal quality, signal robustness, or a combination thereof.

In one or more embodiments, and in response to receiving the alert, the infrastructure system 110 is additionally configured to transmit one or more instructions to a base station 310. As an example, the one or more instructions transmitted to the base station 310 can include instructions for deploying one or more signal-boosting drones 312 to the particular trouble spot corresponding to the alert received by the infrastructure system 110 to temporarily resolve the connectivity-related issue(s) so that marshaling of the vehicle 102 (e.g., and/or the one or more additional vehicles 142 is not disturbed). It is understood that any signal-boosting device (e.g., flying or non-flying) can be deployed alternatively to, or in addition to, the one or more signal-boosting drones 312.

As another example, the one or more signal-boosting drones 312 can be deployed from an external holding facility monitored and/or in communication with the infrastructure system 110. However, it is understood that the one or more signal-boosting drones 312 can be deployed from a holding facility located anywhere in relation to the manufacturing environment that is monitored and/or in communication with the infrastructure system 110. As yet another example, any connectivity-related issues associated with any of the trouble spots 306a-306d can be mitigated by the deployment of the one or more signal-boosting drones 312. As a further example, the mitigation of the connectivity-related issue(s) provided by the one or more signal-boosting drones 312 is accomplished by the configuration of the one or more signal-boosting drones 312 that increases the signal strength in the particular trouble spot(s) corresponding to the alert received by the infrastructure system 110.

In one or more embodiments, the infrastructure system 110, and in response to the vehicle 102 (e.g., and/or the one or more additional vehicles 142) being outside a field of view associated with the set of infrastructure sensors 302, is further configured to transmit the one or more instructions to the base station 310 for deploying the one or more signal-boosting drones 312 to a last-known location of the vehicle (e.g., and/or the one or more additional vehicles 142). In one or more examples, the deployment of the one or more signal-boosting drones 312 to the last-known location of the vehicle 102 (e.g., and/or the one or more additional vehicles 142) can provide for the infrastructure system 110 to continue monitoring the progression of the vehicle 102 (e.g., and/or the one or more additional vehicles 142), which is accomplished based on transmission of a video stream (or other monitoring data) obtained by one or more sensors (not shown) of the one or more signal-boosting drones 312 to the infrastructure system 110.

In one or more examples, each signal-boosting drone of the one or more signal-boosting drones 312 is configured to be attachable in relation to the vehicle 102 (e.g., and/or the one or more additional vehicles 142). In other words, upon deployment of the one or more signal-boosting drones 312, the one or more signal-boosting drones 312 is configured to attach to a magnetic sensor or a beacon associated with the vehicle 102 (e.g., and/or the one or more additional vehicles 142) so that the one or more signal-boosting drones 312 can maintain a state of charge. As an example, and through the attachment of the vehicle 102 (e.g., and/or the one or more additional vehicles 142) with the one or more signal-boosting drones 312, the one or more signal-boosting drones 312, which are affixed to a charging pad, are configured to provide its location to the infrastructure system 110 and/or return to a base (e.g., the holding facility).

In one or more examples, each signal-boosting drone of the one or more signal-boosting drones 312 has one or more beacons (not shown) installed thereupon and are configured to guide correct attachment of the one or more signal-boosting drones 312 to the vehicle 102 (e.g., and/or the one or more additional vehicles 142). Each beacon of the one or more beacons is also configured to wirelessly communicate with other beacons indicating its location to one another and/or to the infrastructure system 110. As another example, and based on the wireless communication between beacons and/or the infrastructure system 110, the one or more signal-boosting drones 312 are configured to switch vehicles in response to the vehicle 102 (e.g., and/or the one or more additional vehicles) entering into any of the trouble spots 306a-306d. In other words, the one or more signal-boosting drones 312 are configured to detach from a vehicle traveling outside any of the trouble spots 306a-306d to attach itself to the vehicle 102 (e.g., and/or the one or more additional vehicles) entering into any of the trouble spots 306a-306d.

In one or more embodiments, and as an alternative or in combination with the deployment of the one or more signal-boosting drones 312 utilized to mitigate the one or more connectivity-related issues, each surrounding vehicle (e.g., the one or more additional vehicles 142) is configured to operate as signal-repeaters to extend a signal range, a signal strength, a signal quality, or a combination thereof among others. For example, each vehicle (e.g., the vehicle 102 and/or the one or more additional vehicles 142) is configured to report its movement to the infrastructure system 110 as well as verify a location associated with other vehicles within the marshaling environment. As another example, each vehicle (e.g., the vehicle 102 and/or the one or more additional vehicles 142) is also configured to store its last known state that corresponds to a vehicle status associated with an instance wherein the vehicle last has a communication-supportive signal. As yet another example, upon initiation of an ignition cycle, the vehicle will transmit its last known state to the infrastructure system 110, which is indicative of vehicle information such as, but not limited to, any faults, location of the vehicle, and battery status, among others. As a further example, each vehicle is equipped with the vehicle-side AVM algorithm 122, which is utilized to determine when a vehicle is entering into any of the trouble spots 306a-306d. In an instance wherein the vehicle is entering into any of the trouble spots 306a-306d, the vehicle can use any vehicle (and any number of vehicles) outside of the trouble spots 306a-306d as a signal-repeater to maintain the communication link with the infrastructure system 110.

In one or more embodiments, the infrastructure system 110 is configured to stitch any of the received media content received from the vehicle 102 (e.g., and/or the one or more additional vehicles 142) and/or the one or more signal-boosting drones 312 to generate a seamless video product corresponding to a dynamically adjusted, and real-time, video feed of the manufacturing environment.

In one or more embodiments, the infrastructure system 110 is configured to utilize the infrastructure-side AVM algorithm 112 to generate a virtual dynamic real-time heat map indicative of each of the one or more trouble spots 306a-306d. For example, the generation of the virtual dynamic real-time heat map is based on the alert. As another example, the alert can include information associated with RF-performance-related metrics, a current position of the vehicle 102 (e.g., and/or the one or more additional vehicles 142), one or more timestamps, snap-shot data or a combination thereof. As yet another example, the infrastructure-side AVM algorithm 112 is configured to pair coordinates (e.g., X-, Y-, and or Z-coordinates) with at least the snap-shot data and the one or more timestamps to generate the virtual dynamic real-time heat map.

As a further example, the snap-shot data can originate from the one or more vehicle sensors 130. The virtual dynamic real-time heat map can be displayed on a user device (e.g., the user device 152) so that a system operator (e.g., the user 140) may view the marshaling environment therefrom. As an example, the one or more trouble spots 306a-306d can be represented by varying shades and/or colors that are indicative of a severity of the interference and/or degradation of the cellular connectivity in a particular area associated with the marshaling environment.

It is understood that while any of the mitigation-related actions described herein may be performed in response to receiving the alert among other triggering actions, any of the mitigation-related actions may be performed in a preemptive manner based on a predictive analysis performed by the vehicle-side AVM algorithm 122 and/or the infrastructure-side AVM algorithm 112. In one or more examples, the predictive analysis can utilize one or more historical reports (stored in a database associated with the vehicle 102, the one or more additional vehicles 142, and/or the infrastructure system 110) of connectivity-related issues corresponding to various areas of the marshaling environment to determine where a connectivity-related issue may likely arise within the marshaling environment.

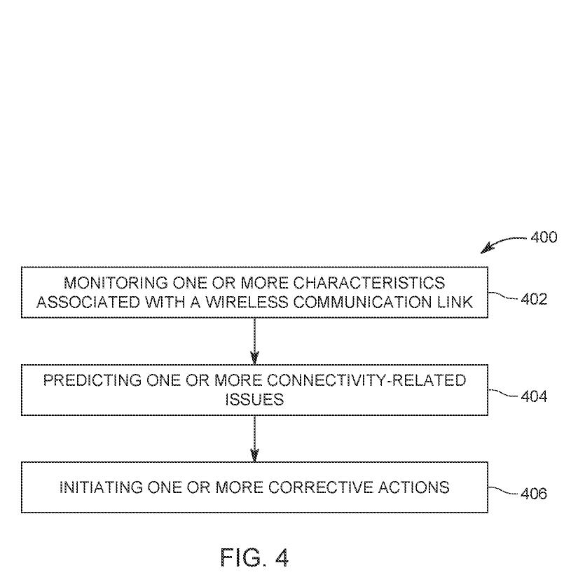

FIG. 4 is a flowchart illustrating an example method 400 for identifying one or more connectivity-related issues in a marshaling environment and deploying various solutions for addressing the one or more connectivity-related issues, as is described herein.

At operation 402, a vehicle system (e.g., the vehicle controller 200) is configured to monitor one or more characteristics associated with a first wireless communication link between an automated vehicle (e.g., the vehicle 102) and an infrastructure system (e.g., the infrastructure system 110). In one or more examples, the one or more characteristics associated with the first wireless communication link between the automated vehicle and the infrastructure system includes a signal strength, a signal quality, or a combination thereof.

At operation 404, the vehicle system is also configured to predict one or more connectivity-related issues associated with the first wireless communication link. As an example, the prediction of the one or more connectivity-related issues associated with the first wireless communication link is based on one or more inputs. As another example, the one or more inputs includes radio-frequency sensor data, a time associated with the one or more characteristics, a temperature, a humidity, or a combination thereof. In one or more examples, the prediction of the one or more connectivity-related issues associated with the first wireless communication link includes the vehicle system determining whether a received signal strength satisfies a signal strength-related threshold. In one or more other examples, the prediction of the one or more connectivity-related issues associated with the first wireless communication link includes the vehicle system determining whether a signal-to-noise ratio or a bit error rate satisfies a signal quality-related threshold.

At operation 406, the vehicle system is further configured to initiate one or more corrective actions. As an example, the initiation of the one or more corrective actions is performed in response to predicting the one or more connectivity-related issues. As another example, the one or more corrective actions includes causing one or more signal-boosting drones to be deployed within proximity of the automated vehicle. In one or more examples, causing the one or more signal-boosting drones to be deployed within proximity of the automated vehicle includes the vehicle system establishing a second communication link between the one or more signal-boosting drones and the automated vehicle as well as mitigating the one or more connectivity-related issues in response to the establishment of the second communication link. As an example, the mitigation of the one or more connectivity-related issues causes the first communication link to satisfy a signal strength-related threshold and a signal quality-related threshold.

In one or more examples, the initiation of the one or more corrective actions includes the vehicle system establishing a second communication link between the automated vehicle and one or more adjacent vehicles relative to the automated vehicle as well as mitigating the one or more connectivity-related issues in response to the establishment of the second communication link. As an example, the mitigation of the one or more connectivity-related issues causes the first communication link to satisfy a signal strength-related threshold and a signal quality-related threshold.

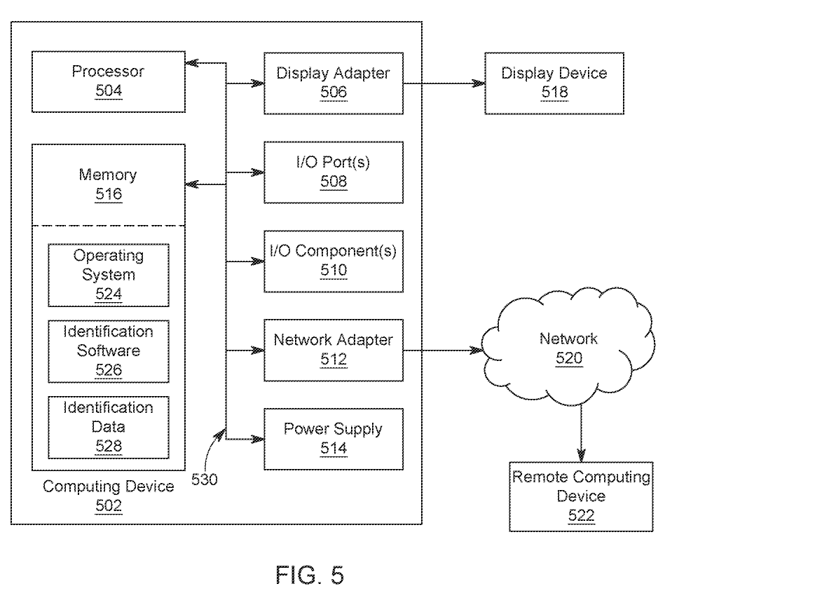

FIG. 5 illustrates an operating environment, such as a computer system, that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, identification software 526, and identification data 528. For example, the operating system 524 is configured to manage and/or process any of the data and/or instructions associated with the identification software 526 and/or identification data 528, as described in more detail herein, such as to identify the trouble spots 306.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provide a means for equipping a vehicle to self-identify one or more connectivity-related issues in a marshaling environment and causing various solutions for addressing the one or more connectivity-related issues to be implemented. For example, one or more signal-boosting drones can be deployed to a particular area of the marshaling environment and/or surrounding vehicles can be used as signal-boosting entities, among other signal-boosting methods described herein.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
monitoring one or more characteristics associated with a first wireless communication link between an automated vehicle and an infrastructure system;
predicting one or more connectivity-related issues associated with the first wireless communication link based on one or more inputs; and
initiating one or more corrective actions in response to predicting the one or more connectivity-related issues, wherein the one or more corrective actions includes causing one or more signal-boosting drones to be deployed within proximity of the automated vehicle.

2. The method of claim 1, wherein the one or more characteristics associated with the first wireless communication link between the automated vehicle and the infrastructure system includes a signal strength, a signal quality, or a combination thereof.

3. The method of claim 1, wherein the prediction of the one or more connectivity-related issues associated with the first wireless communication link comprises:
determining whether a received signal strength satisfies a signal strength-related threshold.

4. The method of claim 1, wherein the prediction of the one or more connectivity-related issues associated with the first wireless communication link comprises:
determining whether a signal-to-noise ratio or a bit error rate satisfies a signal quality-related threshold.

5. The method of claim 1, wherein the one or more inputs includes radio-frequency sensor data, a time associated with the one or more characteristics, a temperature, a humidity, or a combination thereof.

6. The method of claim 1, wherein causing the one or more signal-boosting drones to be deployed within proximity of the automated vehicle comprises:
establishing a second communication link between the one or more signal-boosting drones and the automated vehicle; and
mitigating the one or more connectivity-related issues in response to the establishment of the second communication link, wherein the mitigation of the one or more connectivity-related issues causes the first communication link to satisfy a signal strength-related threshold and a signal quality-related threshold.

7. The method of claim 1, wherein the initiation of the one or more corrective actions further comprises:
establishing a second communication link between the automated vehicle and one or more adjacent vehicles relative to the automated vehicle; and
mitigating the one or more connectivity-related issues in response to the establishment of the second communication link, wherein the mitigation of the one or more connectivity-related issues causes the first communication link to satisfy a signal strength-related threshold and a signal quality-related threshold.

8. A system comprising:
a vehicle system configured to:
monitor one or more characteristics associated with a first wireless communication link between an automated vehicle and an infrastructure system,
predict one or more connectivity-related issues associated with the first wireless communication link based on one or more inputs, and
initiate one or more corrective actions in response to predicting the one or more connectivity-related issues; and
one or more signal-boosting drones configured to:
proceed to a location within a proximity of the automated vehicle in response to the initiation of the one or more corrective actions.

9. The system of claim 8, wherein the one or more characteristics associated with the first wireless communication link between the automated vehicle and the infrastructure system includes a signal strength, a signal quality, or a combination thereof.

10. The system of claim 8, wherein the vehicle system configured to predict the one or more connectivity-related issues associated with the first wireless communication link is further configured to:
determine whether a received signal strength satisfies a signal strength-related threshold; or
determine whether a signal-to-noise ratio or a bit error rate satisfies a signal quality-related threshold.

11. The system of claim 8, wherein the one or more inputs includes radio-frequency sensor data, a time associated with the one or more characteristics, a temperature, a humidity, or a combination thereof.

12. The system of claim 8, wherein the vehicle system is further configured to:
establish a second communication link between the one or more signal-boosting drones and the automated vehicle; and
mitigate the one or more connectivity-related issues in response to the establishment of the second communication link, wherein the mitigation of the one or more connectivity-related issues causes the first communication link to satisfy a signal strength-related threshold and a signal quality-related threshold.

13. The system of claim 8, wherein the vehicle system is further configured to:
establish a second communication link between the automated vehicle and one or more adjacent vehicles relative to the automated vehicle; and
mitigate the one or more connectivity-related issues in response to the establishment of the second communication link, wherein the mitigation of the one or more connectivity-related issues causes the first communication link to satisfy a signal strength-related threshold and a signal quality-related threshold.

14. The system of claim 8, wherein the infrastructure system is configured to:
stitch one or more sensor-related outputs received from the one or more signal-boosting drones and one or more adjacent vehicles relative to the automated vehicle;
adjust, based on stitching the one or more sensor-related outputs, a radio-frequency signal frequency, an antenna output power, or a combination thereof; and
cause the one or more connectivity-related issues to be mitigated in response to the adjustment of the radio-frequency signal frequency, the antenna output power, or the combination thereof.

15. One or more non-transitory computer-readable media storing processor-executable instructions that, when executed by at least one processor, cause the at least one processor to:
monitor one or more characteristics associated with a first wireless communication link between an automated vehicle and an infrastructure system;
predict one or more connectivity-related issues associated with the first wireless communication link based on one or more inputs; and
initiate one or more corrective actions in response to predicting the one or more connectivity-related issues, wherein the one or more corrective actions includes causing one or more signal-boosting drones to be deployed within proximity of the automated vehicle.

16. The one or more non-transitory computer-readable media of claim 15, wherein the one or more characteristics associated with the first wireless communication link between the automated vehicle and the infrastructure system includes a signal strength, a signal quality, or a combination thereof.

17. The one or more non-transitory computer-readable media of claim 15, wherein the at least one processor caused to predict the one or more connectivity-related issues associated with the first wireless communication link is further caused to:
determine whether a received signal strength satisfies a signal strength-related threshold; or
determine whether a signal-to-noise ratio or a bit error rate satisfies a signal quality-related threshold.

18. The one or more non-transitory computer-readable media of claim 15, wherein the one or more inputs includes radio-frequency sensor data, a time associated with the one or more characteristics, a temperature, a humidity, or a combination thereof.

19. The one or more non-transitory computer-readable media of claim 15, wherein the at least one processor caused to cause the one or more signal-boosting drones to be deployed within proximity of the automated vehicle is further caused to:
establish a second communication link between the one or more signal-boosting drones and the automated vehicle; and
mitigate the one or more connectivity-related issues in response to the establishment of the second communication link, wherein the mitigation of the one or more connectivity-related issues causes the first communication link to satisfy a signal strength-related threshold and a signal quality-related threshold.

20. The one or more non-transitory computer-readable media of claim 15, wherein the at least one processor caused to initiate the one or more corrective actions is further caused to:
establish a second communication link between the automated vehicle and one or more adjacent vehicles relative to the automated vehicle; and
mitigate the one or more connectivity-related issues in response to the establishment of the second communication link, wherein the mitigation of the one or more connectivity-related issues causes the first communication link to satisfy a signal strength-related threshold and a signal quality-related threshold.
